(19) United States
(12) Patent Application Publication
(10) Pub. No.: US 2024/0397336 A1
(43) Pub. Date: Nov. 28, 2024

(54) PAGING ENHANCEMENTS TO GNB FOR RADAR COEXISTANCE

(71) Applicant: INTERDIGITAL PATENT HOLDING, INC., Wilmington, DE (US)

(72) Inventors: Joseph Murray, Schwenksville, PA (US); Sudhir Pattar, Mount Laurel, NJ (US); Alpaslan Demir, East Meadow, NY (US); Joe Huang, Montville, NJ (US); Muhammad Fazili, Audubon, PA (US); Tariq Elkourdi, Belleville, NJ (US); Patrick Cabrol, Bayshore, NY (US); Philip Pietraski, Jericho, NY (US); Paul Russell, Lawrence, NJ (US)

(73) Assignee: INTERDIGITAL PATENT HOLDING, INC., Wilmington, DE (US)

(21) Appl. No.: 18/693,689

(22) PCT Filed: Sep. 28, 2022
(86) PCT No.: PCT/US2022/044989

§ 371 Date: Mar. 20, 2024

Related U.S. Application Data
(60) Provisional application No. 63/249,977, filed on Sep. 29, 2021.

(51) Int. Cl. H04W 16/14; H04W 68/02

(52) U.S. Cl. CPC H04W 16/14; H04W 68/02

(57) ABSTRACT

A method of interference mitigation performed by a base station, the method comprising: receiving radar operation information; determining interference based on the radar operation information; and based on the interference determination, dynamically reconfiguring a paging configuration operated by the base station to minimize or eliminate an impact of the interference.

### CROSS-REFERENCE TO RELATED APPLICATIONS

This application claims the benefit of U.S. Provisional Application No. 63/390,100, filed Jul. 18, 2002, and U.S. Provisional Application No. 63/249,977, filed Sep. 29, 2021, the contents of which are incorporated herein by reference.

### BACKGROUND

Advanced network standards, including 5G New Radio (NR) standards do not typically specify practical network embodiments that can operate in highly congested and contested spectral environments in which transceivers are vulnerable to jamming and in which non-telecommunications equipment such as radar transceivers propagate energy in bands used by advanced networks. Yet, this is the environment in which such advanced networks are deployed. Systems apparatus and methods are needed by which devices and systems implementing advanced networking technologies such as 5G technologies can operate optimally while coexisting with devices and systems that propagate energy in the same bands used by the networks, without the networks interfering with the propagated energy, and vice versa.

### SUMMARY

In one or more embodiments disclosed herein, there may be one or more methods, systems, and/or devices that ensure robust and efficient paging transmission and reception when two wireless systems coexist (e.g., 5G and RADAR). For example, there may be methods for RADAR coexistence using the RRC Suspend/Resume procedure. For example, there may be methods for RADAR coexistence using dynamic reconfiguration of the paging configuration. For example, there may be methods for RADAR coexistence using paging configurations with multiple PDCCH monitoring occasions per SSB.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of illustrating an embodiment of dynamic reconfiguration of paging configuration using PF_OFFSET;

FIG. 3 is a diagram illustrating an embodiment of dynamic reconfiguration of paging configuration using firstPDCCH-MonitoringOccasionOfPO;

FIG. 4 is a diagram illustrating an embodiment of dynamic reconfiguration of paging configuration using pagingSearchSpace;

FIG. 5 is a diagram illustrating an embodiment of dynamic reconfiguration of paging configuration using CORESET;

FIG. 6 is a diagram illustrating an embodiment of exemplary paging occasion definition corresponding to a paging configuration where S=3 and X=2;

FIG. 7 is a diagram illustrating an embodiment of a scenario where interference to/from the RADAR occurs during PDCCH monitoring occasion; and

FIG. 8 is a diagram illustrating an embodiment of a paging occasion configured with different CORESETs for each sweep; and

FIG. 9 is a system diagram according to embodiments.

### DETAILED DESCRIPTION

As used herein, there may be one or more acronyms using the following abbreviations: 5G-5th Generation; AOA-Angle of Arrival; BW-Bandwidth; CMAS-Commercial Mobile Alert Service; CN-Core Network; CORESET-Control Resource Set; CRC-Cyclic Redundancy Check; CSI-RS-Channel State Information Reference Signal; DCI-Downlink Control Information; DRX-Discontinuous Reception; ETWS-Earthquake and Tsunami Warning System; gNB-NR NodeB; MAC-Medium Access Control; MCS-Modulation and Coding Scheme; OFDM-Orthogonal Frequency Division Multiplexing; PCCH-Paging Control Channel; PDCCH-Physical Downlink Control Channel; PDSCH-Physical Downlink Shared Channel; PF-Paging Frame; PHY-Physical Layer; PO-Paging Occasion; PRB-Physical Resource Block; PSD-Power Spectral Density; QCL-Quasi-Collocated; RADAR-Radio Detection and Ranging; RB-Resource Block; RRC-Radio Resource Control; SFN-System Frame Number; SIB-System Information Block; SSB-SS/PBCH block; TB-Transport Block; TMSI-Temporary Mobile Subscriber Identity; TOA-Time of Arrival; UE-User Equipment; VRB-Virtual Resource Block.

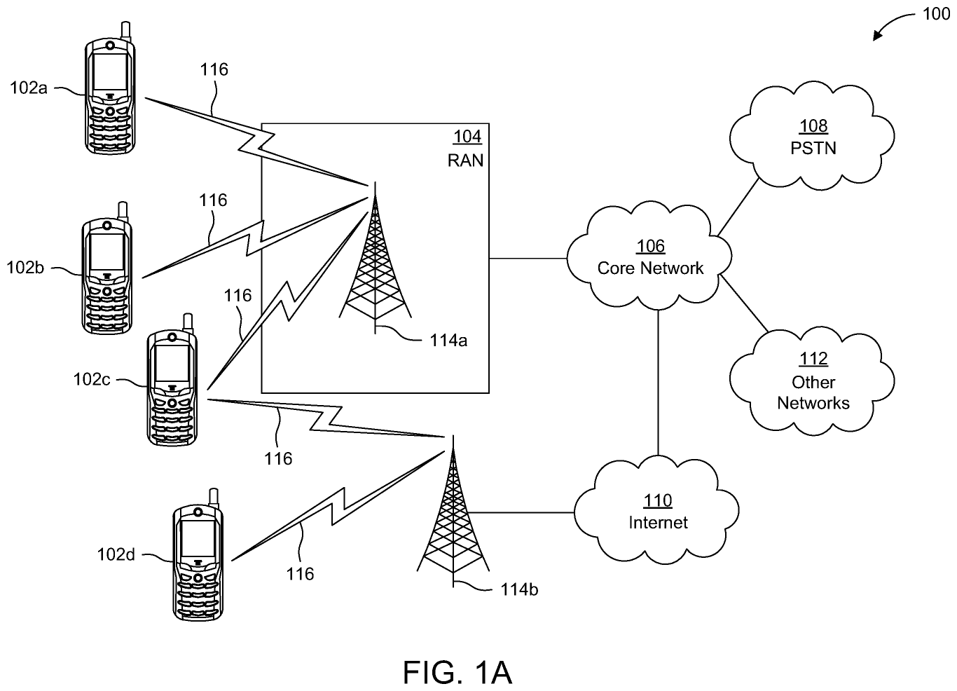

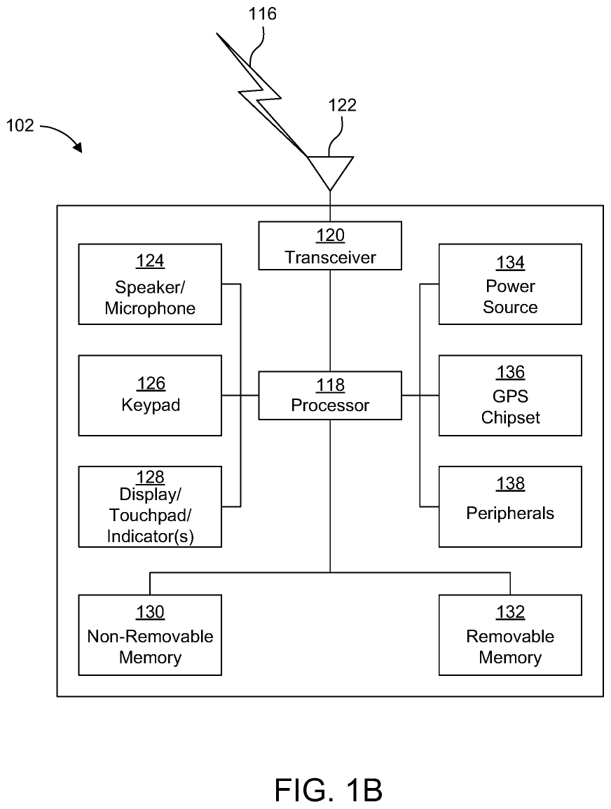

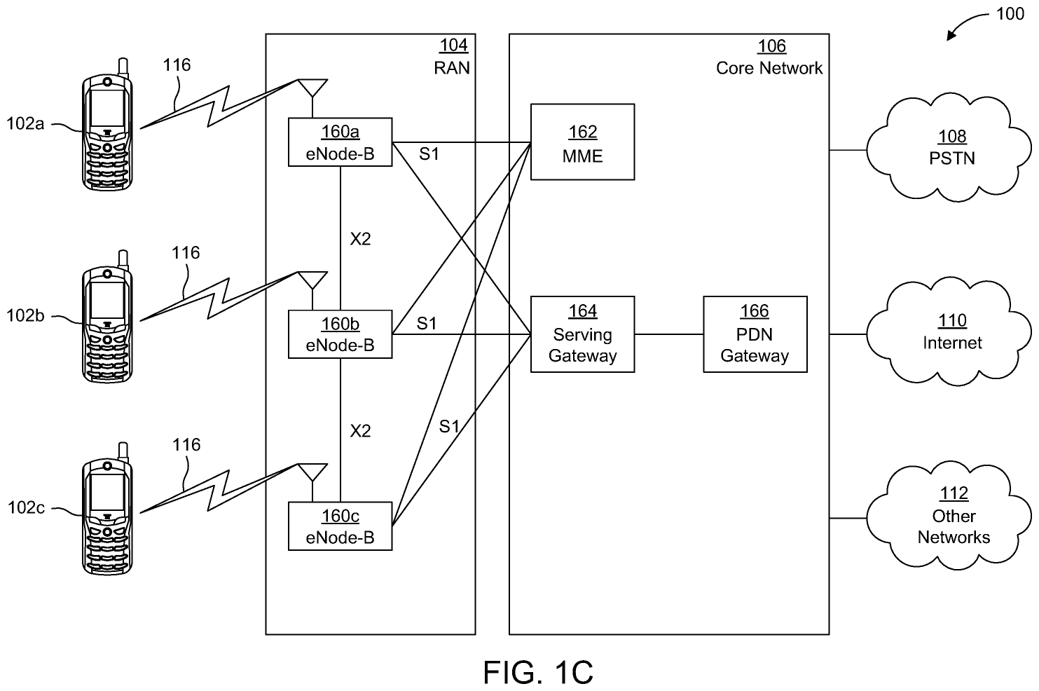

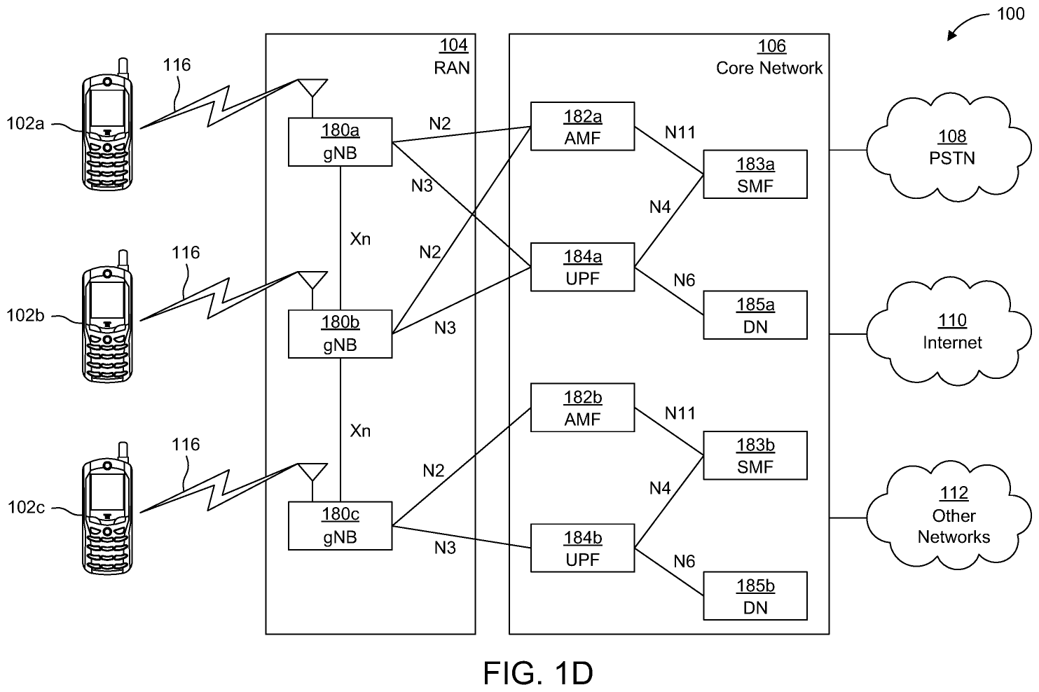

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In one or more embodiments, a WTRU can operate with discontinuous reception for paging situations. A WTRU can use Discontinuous Reception (DRX) in RRC_IDLE and RRC_INACTIVE state in order to reduce power consumption. In such a situation, the WTRU can monitor one paging occasion (PO) per DRX cycle. A PO may be a set of PDCCH monitoring occasions and can comprise of one or more time increments (e.g., subframe, slot, OFDM symbol, etc.) where paging control information (e.g., DCI) may be sent. One Paging Frame (PF) may be one Radio Frame and may contain one or multiple PO(s) or starting point of a PO.

In embodiments of multi-beam operations, the WTRU can assume that the same paging message and the same Short Message are repeated in all transmitted beams and thus the selection of the beam(s) for the reception of the paging message and Short Message is up to WTRU implementation. The paging message can be the same for both RAN initiated paging and CN initiated paging.

The WTRU can initiate a RRC Connection Resume procedure upon receiving a RAN initiated paging. If the WTRU receives a CN initiated paging in RRC_INACTIVE state, the WTRU may move to RRC_IDLE and inform a NAS.

The PF and PO for paging can be determined by the following formula: SFN for the PF is determined by

(SFN+PF_offset) mod T=(T div N)*(WTRU_ID mod N); and Index (i_s), indicating the index of the PO is determined by i_s=floor (WTRU_ID/N) mod Ns.

The PDCCH monitoring occasions for paging can be determined according to pagingSearchSpace a and firstPDCCH-MonitoringOccasionOfPO if configured. When SearchSpaceID=0 is configured for pagingSearchSpace, the PDCCH monitoring occasions for paging can be the same as for RMSI.

When SearchSpaceID=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceld other than 0 is configured for pagingSearchSpace, the WTRU can monitor the (i_s+1)^{th} PO. A PO can be a set of ‘S’ consecutive PDCCH monitoring occasions where ‘S’ is the number of actual transmitted SSBs determined according to ssb-PositionsinBurst in SIB1. The Kth PDCCH monitoring occasion for paging in the PO corresponds to the Kth transmitted SSB. The PDCCH monitoring occasions for paging which do not overlap with UL symbols (e.g., determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S.

In some cases, a PO that is associated with a PF can start in the PF or after the PF. In some cases, the PDCCH monitoring occasion for a PO can span multiple radio frames. When SearchSpaceID other than 0 is configured for paging-SearchSpace the PDCCH monitoring occasions for a PO can span multiple periods of the paging search space.

The following parameters are example values that can be used for the calculation of PF and i_s above: T is the DRX cycle of the WTRU (T is determined by the shortest of the WTRU specific DRX value(s), if configured by RRC and/or upper layers, and a default DRX value broadcast in system information. In RRC_IDLE state, if WTRU specific DRX is not configured by upper layers, the default value is applied); N is the number of total paging frames in T; Ns is the number of paging occasions for a PF; PF_offset is the offset used for PF determination; WTRU_ID is the 5G-S-TMSI mod 1024.

Parameters Ns, nAndPagingFrameOffset, and the length of default DRX Cycle may be signaled in SIB1. The values of N and PF_offset can be derived from the parameter nAndPagingFrameOffset. The parameter first-PDCCH-MonitoringOccasionOfPO can be signaled in SIB1 for paging in an initial downlink bandwidth part (DL BWP). For paging in a DL BWP other than the initial DL BWP, the parameter first-PDCCH-MonitoringOccasionOfPO can be signaled in the corresponding BWP configuration.

If the WTRU has no 5G-S-TMSI, for instance when the WTRU has not yet registered onto the network, the WTRU can use as default identity WTRU_ID=0 in the PF and i_s formulas above.

5G-S-TMSI may be a 48 bit long bit string. 5G-S-TMSI shall in the formulae above be interpreted as a binary number where the left most bit represents the most significant bit.

For a paging DCI, the following information in Table 1 can be transmitted by means of a DCI (e.g., format 1_0 with CRC scrambled followed by P-RNTI). Table 2 shows an example of short message indicator.

TABLE 1
Paging DCI

| Field Name | # Bits | Comment |
|---|---|---|
| Short Messages Indicator | 2 | As defined in Table 2. |
| Short Messages | 8 | If only the scheduling information for |
| | | Paging is carried, this bit field is |
| | | reserved. |
| Frequency domain resource | ┌log₂ (N_{RB}^{RDL, BWP}/ | If only the short message is carried, |
| assignment | (N_{RB}^{DL, BWP} + 1)/2)┐ | this bit field is reserved. |
| Time domain resource | 4 | If only the short message is carried, |
| assignment | | this bit field is reserved. |
| VRB-to-PRB mapping | 1 | If only the short message is carried, |
| | | this bit field is reserved. |
| Modulation and coding | 5 | If only the short message is carried, |
| scheme | | this bit field is reserved. |
| TB scaling | 2 | If only the short message is carried, |
| | | this bit field is reserved. |
| Reserved | 6 | |

TABLE 2
Short Message Indicator

| Bit Field | Description |
|---|---|
| 00 | Reserved |
| 01 | Only scheduling information for Paging is |
| | present in the DCI |
| 10 | Only short message is present in the DCI |
| 11 | Both scheduling information for Paging and |
| | short message are present in the DCI |

For PCCH configuration, the IE DownlinkConfig CommonSIB can provide common downlink parameters of a cell. This IE can include the PCCH-Config field, which can be used to provide the DRX configuration for the cell. Table 3 is an example of the PCCH-config field. Table 4 is an example of the PCCH-config field descriptions.

TABLE 3
PCCH-Config Field

| | |
|---|---|
| PCCH-Config ::= | SEQUENCE { |

| | |
|---|---|
| defaultPagingCycle | PagingCycle, |
| nAndPagingFrameOffset | CHOICE { |

| | |
|---|---|
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |

firstPDCCH-MonitoringOccasionOfPO CHOICE {

| | |
|---|---|
| sCS15KHZoneT | SEQUENCE (SIZE (1..maxPO-perPF)) OF INTEGER (0..139), |
| sCS30KHZoneT-SCS15KHZhalfT | SEQUENCE (SIZE (1..maxPO-perPF)) OF INTEGER (0..279), |
| sCS60KHZoneT-SCS30KHZhalfT-SCS15KHZquarterT | SEQUENCE (SIZE (1..maxPO-perPF)) OF INTEGER (0..559), |

| | |
|---|---|
| sCS120KHZoneT-SCS60KHZhalfT-SCS30KHZquarterT-SCS15KHZoneEighthT | SEQUENCE (SIZE (1..maxPO-perPF)) OF INTEGER |

(0..1119),
sCS120KHZhalfT-SCS60KHZquarterT-SCS30KHZoneEighthT-SCS15KHZoneSixteenthT

SEQUENCE (SIZE (1..maxPO-perPF)) OF INTEGER (0..2239),

| sCS120KHZquarterT-SCS60KHZoneEighthT-SCS30KHZoneSixteenthT | SEQUENCE (SIZE (1..maxPO-perPF)) OF INTEGER |
|---|---|
| | (0..4479), |

| | |
|---|---|
| sCS120KHZoneEighthT-SCS60KHZoneSixteenthT | SEQUENCE (SIZE (1..maxPO-perPF)) OF INTEGER (0..8959), |
| sCS120KHZoneSixteenthT | SEQUENCE (SIZE (1..maxPO-perPF)) OF INTEGER (0..17919) |

| | |
|---|---|
| } OPTIONAL, | -- Need R |

...
}

TABLE 4
PCCH-Config Field Descriptions

defaultPagingCycle
Default paging cycle, used to derive ‘T’ in TS 38.304. Value rf32 corresponds to 32 radio frames, value
rf64 corresponds to 64 radio frames and so on.
firstPDCCH-MonitoringOccasionOfPO
Points out the first PDCCH monitoring occasion for paging of each PO of the PF, see TS 38.304.
nAndPagingFrameOffset
Used to derive the number of total paging frames in T (corresponding to parameter N in TS 38.304) and
paging frame offset (corresponding to parameter PF_offset in TS 38.304). A value of oneSixteenth T
corresponds to T / 16, a value of oneEighthT corresponds to T / 8, and so on.
If pagingSearchSpace is set to zero and if SS/PBCH block and CORESET multiplexing pattern is 2 or 3
(as specified in TS 38.213):
for ssb-periodicityServingCell of 5 or 10 ms, N can be set to one of {one T, halfT, quarterT,
oneEighth T, oneSixteenth 1}
for ssb-periodicityServingCell of 20 ms, N can be set to one of {halfT, quarterT, oneEighthT,
one Sixteenth 7}
for ssb-periodicityServingCell of 40 ms, N can be set to one of {quarterT, oneEighthT,
oneSixteenth 1}
for ssb-periodicityServingCell of 80 ms, N can be set to one of {oneEighth T, oneSixteenth]}
for ssb-periodicityServingCell of 160 ms, N can be set to oneSixteenthT
If pagingSearchSpace is set to zero and if SS/PBCH block and CORESET multiplexing pattern is 1 (as
specified in TS 38.213), N can be set to one of {halfT, quarterT, oneEighthT, oneSixteenth]}
If pagingSearchSpace is not set to zero, N can be configured to one of {oneT, halfT, quarterT,
oneEighthT, oneSixteenth 1}
ns
Number of paging occasions per paging frame.

For Short Message(s), these can be transmitted on PDCCH using P-RNTI with or without an associated Paging message using a short message field in DCI (e.g., format 1_0). Table 5 is an example of short messages, where Bit 1 is the most significant bit.

TABLE 5
Short Messages

| Bit | Short Message |
|---|---|
| 1 | systemInfoModification |
| | If set to 1: indication of a BCCH modification other than |
| | SIB6, SIB7 and SIB8. |
| 2 | etwsAndCmasIndication |
| | If set to 1: indication of an ETWS primary notification |
| | and/or an ETWS secondary notification and/or a CMAS |
| | notification. |
| 3-8 | Not used in this release of the specification, and shall |
| | be ignored by WTRU if received. |

In one or more embodiments described herein, there are described solutions for the coexistence of multiple wireless systems. For example, for cellular network deployments in the presence of high-power narrowband systems such as RADARs. Although the baseline functionality provided by some wireless systems (e.g., 5G) can be used to provide some level of coexistence with such systems, enhancements are required to realize the full potential of a given wireless system and to mitigate interference to/from a high-power narrowband system.

For example, when a narrow-band high power interferer such as RADAR operates in a band that overlaps with the RBs used by the gNB to transmit paging, the WTRUs may not be able to receive the Paging DCI and/or Paging Message reliably due to a high level of interference from the RADAR. If a WTRU is unable to receive paging reliably, it will be unable to receive a page to establish/resume an RRC connection in response to DL data arrival at the CN; nor will it be able to reliably receive SI change and PWS indications, which are indicated in the Short Message signaled via the Paging DCI. In scenarios where the paging can be received reliably in the presence of the interference, there is the potential for the paging transmission to interfere with the system it is coexisting with, (for example a RADAR system) which is also problematic.

Therefore, when coexisting with high-power narrowband interferers such as RADAR, there is a need for new mechanisms to mitigate interference to/from the high-power narrowband interferer for paging transmissions.

In one or more embodiments disclosed herein, there are described solutions to the above problems, and these approaches can ensure robust and efficient paging transmission and reception when coexisting with RADARs. In one or more embodiments disclosed there are systems, methods, and/or devices for: RADAR Coexistence Using the RRC Suspend/Resume Procedure; RADAR Coexistence Using Dynamic Reconfiguration of the Paging Configuration; and/or, RADAR Coexistence Using Paging Configurations with Multiple PDCCH Monitoring Occasions Per SSB. Although the solutions described herein are contemplated for coexistence with a RADAR, they can also be applied for scenarios in which coexistence with other types of wireless network implemented.

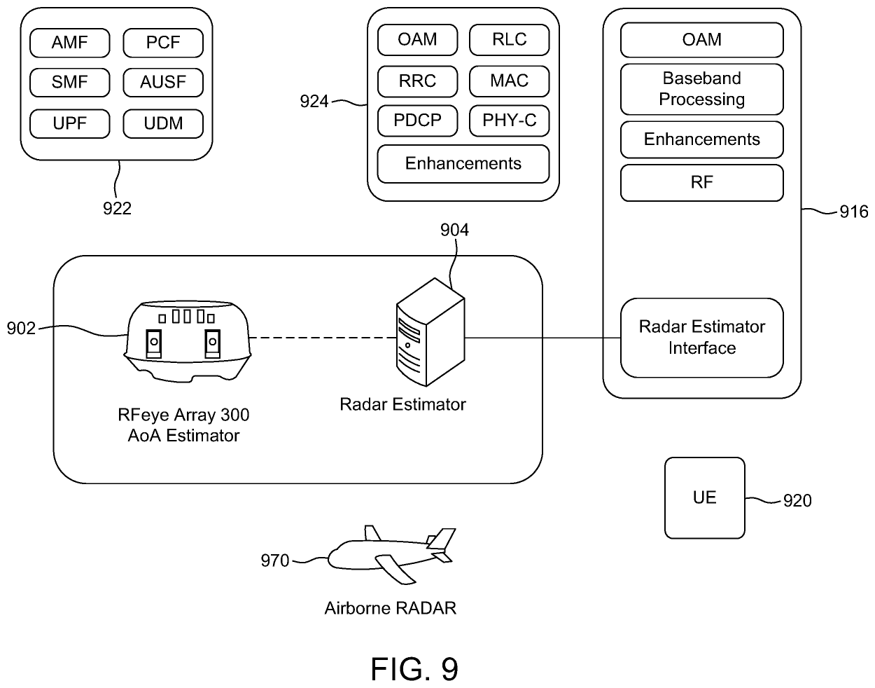

In embodiments for the coexistence of multiple wireless systems, an RRC suspend/resume procedure is utilized. For example, when a 5G system is coexisting with a RADAR, the gNB can suspend the connections for WTRUs in RRC_CONNECTED mode to avoid interference to/from the RADAR. The gNB can use information characterizing the operation of the RADAR and the coverage area of the cells served by the gNB to determine the interference level that would result to/from the RADAR. The gNB can receive information characterizing the operation of the RADAR from an external entity or equipment such as is described below with respect to FIG. 9. Alternatively, the gNB can perform measurements to determine the information characterizing the operation of the RADAR. In an alternative, measurements performed by the gNB can be used in combination with information provided by an external entity to characterize the operation of the RADAR.

In one example, RADAR AOA and the spatial direction of an SSB or CSI-RS that is QCL-ed with the antenna port(s) used for transmission of a PDSCH to a WTRU can be used by the gNB to determine the spatial directions that will incur interference to/from the RADAR in the cells served by the gNB; RADAR pathloss estimates, BW estimates, and/or PSD can be used to determine the interference level to/from the RADAR for specific RBs/REs that will incur interference to/from the RADAR; and RADAR rotation timing estimates, pulse timing estimates, and/or TOA is used to determine the symbols/slots that will incur interference to/from the RADAR.

In embodiments, the gNB can suspend connections for WTRUs that will incur an interference level to/from the RADAR that is above a threshold. The threshold can be preconfigured, determined dynamically, and/or provided by an external entity. Different thresholds can be defined and selected by the gNB. For example, in embodiments, a set of thresholds can be defined based on the MCS or modulation order. The gNB then selects the appropriate threshold based on the MCS or modulation order used for the PDSCH and/or PUSCH transmissions. In further embodiments, the threshold is selected based on characteristics of the data, characteristics of the service, and/or characteristics of the device (e.g., the QoS of the data being transmitted on the PDSCH/PUSCH, the service being provided to the device, the device type).

In embodiments, the message (e.g., RRCRelease) used to suspend the RRC connection can be transmitted using broadcast, groupcast, or dedicated higher layer signaling. The message can include a timer value, suspension Timer to indicate when the WTRU should resume the RRC connection, as shown below. In embodiments, the value of the timer is based on the time required to reconfigure the WTRU to mitigate interference to/from the RADAR. Information characterizing the operation of the RADAR can also be used to determine the value of the timer. For instance, RRC connection is resumed during periods of RADAR inactivity.

| SuspendConfig ::= SEQUENCE { | |
|---|---|
| fullI-RNTI | |
| shortI-RNTI | |
| ran-PagingCycle | |
| ran-NotificationAreaInfo | |
| t380 | |
| suspentionTimer | ENUMERATED {n0, n5, n10, n15, ...} |

nextHopChainingCount
... }

The UE can request RRC connection to resume by transmitting RRCResumeRequest only with resumeCause set to emergency. The network can reject the UE request and continue with the suspended RRC connection or accept the request and release the RRC connection, in which case the suspention Timer is reset to “0”.

In embodiments for handling coexistence of multiple wireless systems, dynamic reconfiguration of the paging configuration is used. For example, to coexist with a RADAR, the gNB dynamically reconfigures the paging configuration such that interference to/from the RADAR is avoided or minimized when performing paging transmission. In embodiments, the gNB uses information characterizing the operation of the RADAR, the paging configuration and/or the coverage area of the cells served the gNB to determine the interference level that would result to/from the RADAR when using a specific PDCCH monitoring occasion for paging. The gNB can receive information characterizing the operation of the RADAR from an external entity or equipment as described below with respect to FIG. 9. In further embodiments, the gNB performs measurements to determine the information characterizing the operation of the RADAR. In further embodiments, measurements performed by the gNB are combined with information provided by an external entity to characterize the operation of the RADAR.

In embodiments, the gNB determines and applies a first paging configuration for each of the cells served by the gNB. The gNB transmits paging in each of the cells in accordance with the corresponding first paging configuration. Upon receiving paging information characterizing the operation of the RADAR, the gNB determines the interference level that would result to/from the RADAR when performing paging transmission.

In embodiments, RADAR AOA and the spatial direction of an SSB or CSI-RS that is QCL-ed with the antenna port(s) are used for transmission of the PDSCH carrying the Paging message is used by the gNB to determine the spatial directions that will incur interference to/from the RADAR in the cells served by the gNB; RADAR pathloss estimates, BW estimates, and/or PSD can be used to determine the interference level to/from the RADAR for specific RBs/REs that will incur interference to/from the RADAR; and RADAR rotation timing estimates, pulse timing estimates, and/or TOA can be used to determine the symbols/slots that will incur interference to/from the RADAR. The pagingSearchSpace and associated CORESET can then be used to determine the interference that would result when using the corresponding PDCCH monitoring occasions for paging. The gNB then determines and applies a second paging configuration for one or more of the cells served by the gNB based on the interference level that would result to/from the RADAR when performing paging transmission.

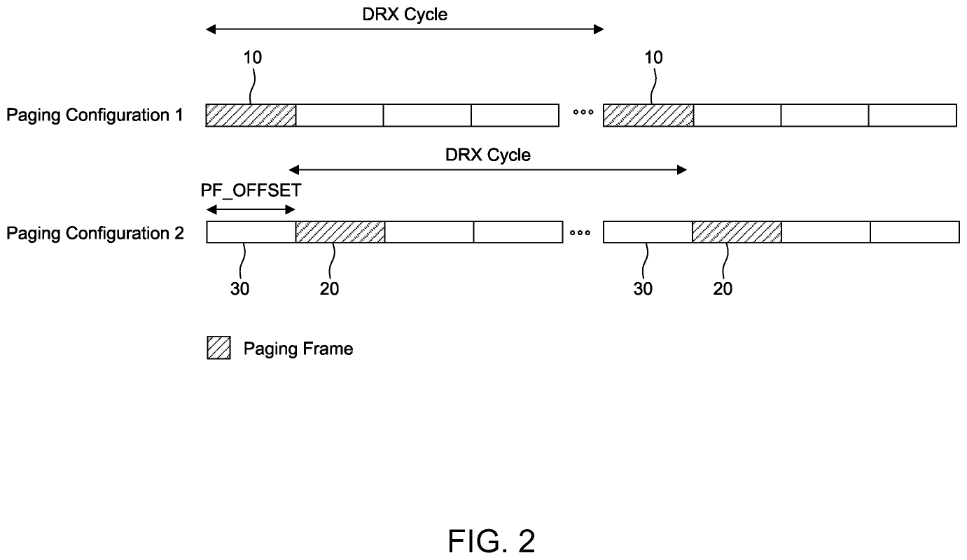

In embodiments, as shown in FIG. 2, the gNB determines a PF_OFFSET that can be used for the second paging configuration to avoid Paging Frames (PF) that may incur interference to/from the RADAR. The Paging Configuration 1 timing diagram shows paging frames 10 with no offset, whereas the Paging Configuration 2 timing diagram shows the paging frames 20 with an offset labeled PF_Offset 30.

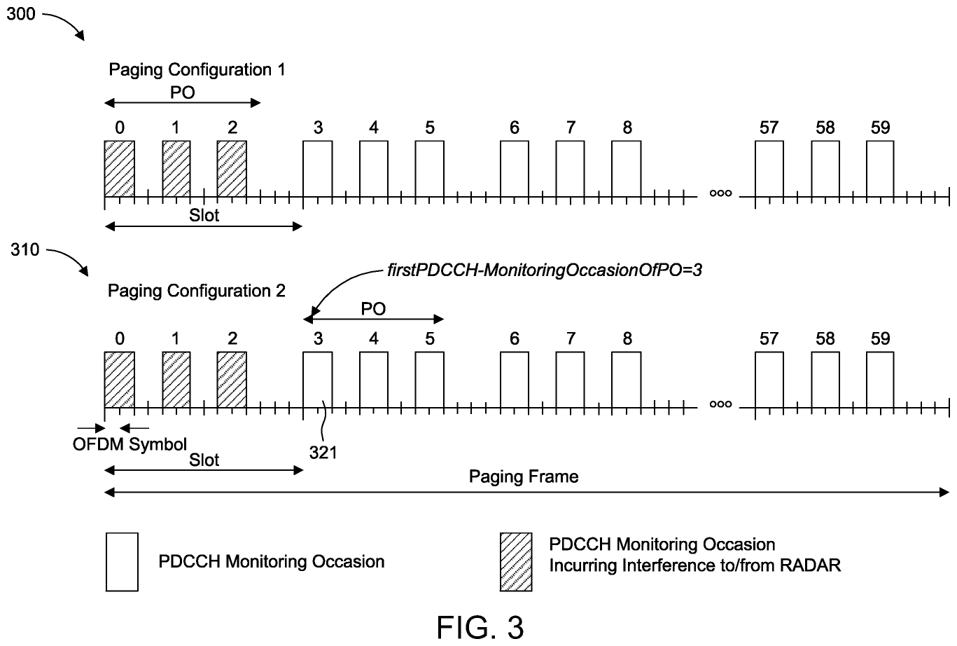

In further embodiments, illustrated in FIG. 3, the gNB determines a firstPDCCH-MonitoringOccasionOfPO 300 for one or more of the POs that may be used for the second paging configuration 310 to avoid PDCCH monitoring occasions that can incur interference to/from the RADAR. FIG. 3 is an illustration of a scenario where the second paging configuration 310uses a firstPDCCH-MonitoringOccasionOfPO=3 321 to avoid interference to/from the RADAR.

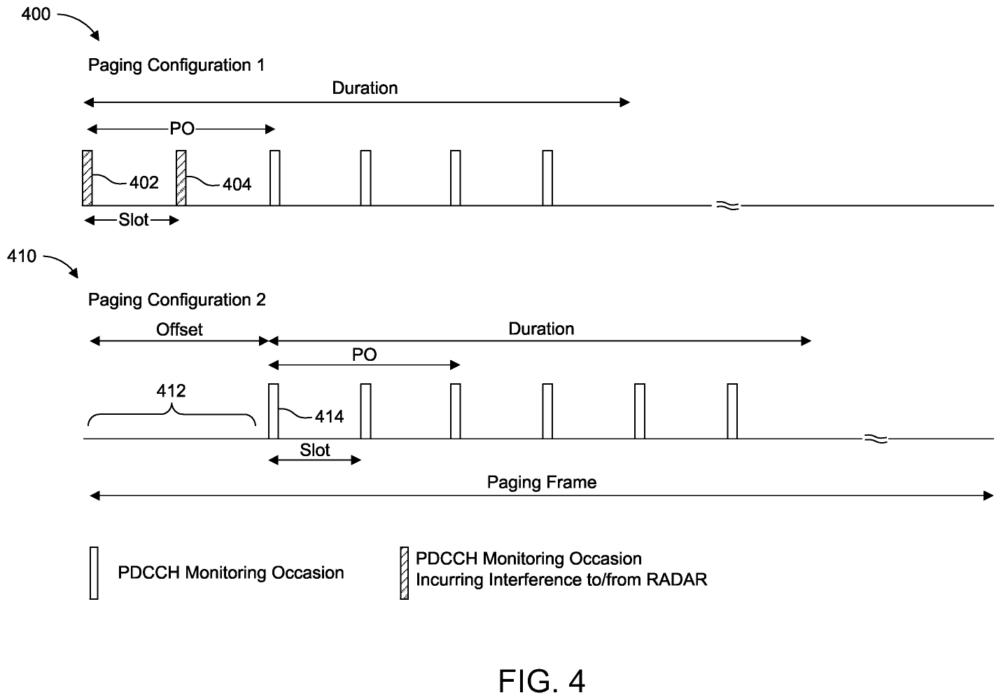

In further embodiments, illustrated in FIG. 4, the gNB determines a pagingSearchSpace corresponding to slots that will not incur interference to/from the RADAR. FIG. 4 is an illustration of an example where the first paging configuration 400 has two PO's 402, 404 that occur in time periods with interference to or from RADAR. The second paging configuration 410 uses a pagingSearchSpace with an offset 412 of two PO's to avoid interference to/from the RADAR.

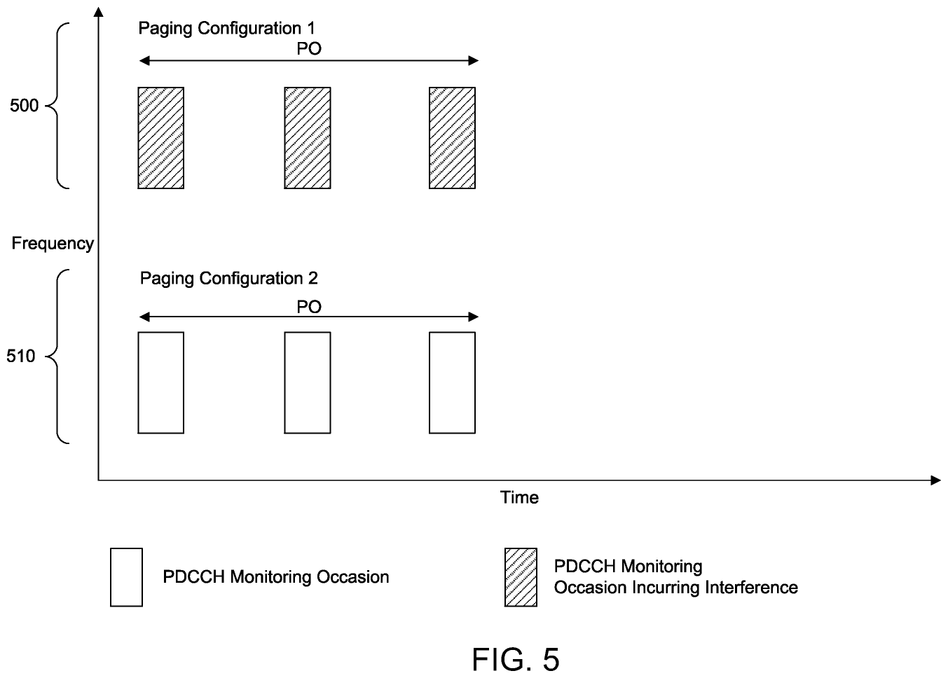

In further embodiments, illustrated in FIG. 5, the gNB determines a CORESET 510 corresponding to RBs that will not incur interference to/from the RADAR, and does not use e.g. CORESET 500 that does incur or cause interference with the RADAR.

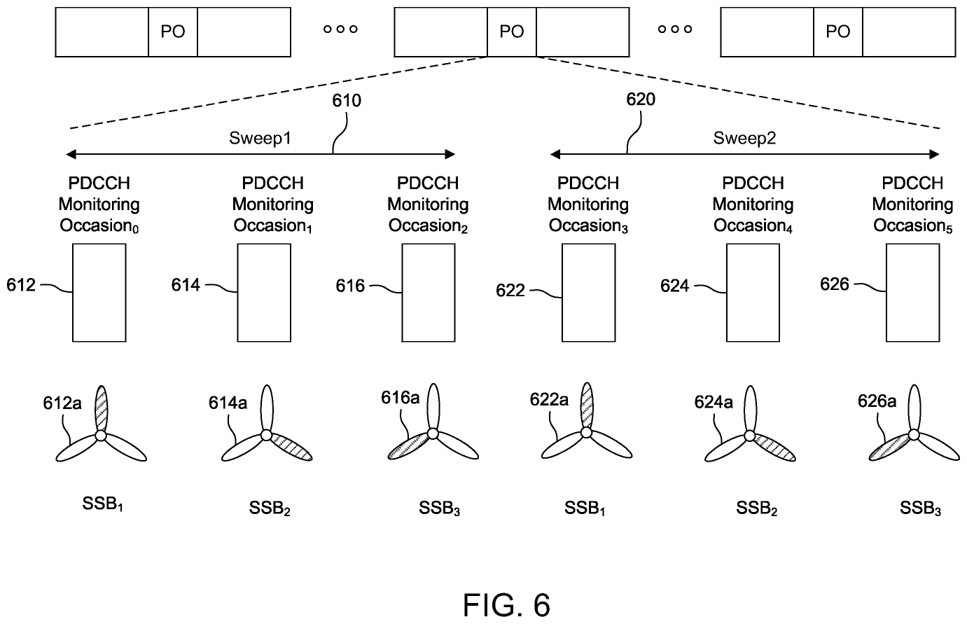

In embodiments, a paging configuration can be used wherein a PO is comprised of a set of ‘S*X’ PDCCH monitoring occasions, where S is the actual number of transmitted SSBs and X is the number of PDCCH monitoring occasions per SSB. The [x*S+K]^{th} PDCCH monitoring occasion for paging in the PO corresponds to the Kth transmitted SSB, where x=0,1, . . . , X−1 and K=1, 2, . . . ,S. An example PO definition corresponding to a paging configuration where S=3 and X=2 is shown in FIG. 6. Monitoring Occasions 612, 614, 616 for Sweep 1, 610 are shown and Monitoring Occasions 622, 624, 626 for Sweep 2, 620 are shown. Corresponding exemplary beam patterns 612a, 614a, 616a, 622a, 624a, 626a are also shown.

When transmitting paging during a PO, the gNB uses a subset of the set of PDCCH monitoring occasions comprising the PO for the actual paging transmission. The subset of PDCCH monitoring occasions is selected such that interference to/from the RADAR is avoided or minimized when using the selected PDCCH monitoring occasions for actual paging transmission.

For example, the subset of PDCCH monitoring occasions is comprised of a total of S PDCCH monitoring occasions, where each of the PDCCH monitoring occasion in the subset corresponds to a different SSB. The PDCCH monitoring occasion corresponding to the Kth SSB is selected from set of X PDCCH monitoring occasions for the SSB such that interference to/from the RADAR is avoided or minimized when using the selected PDCCH monitoring occasion for paging.

In embodiments, selection of one or more PDCCH monitoring occasions is based on the interference level that results to/from the RADAR when using the selected PDCCH monitoring occasion for paging, being below a threshold. In embodiments, different thresholds are defined and selected by the gNB. For example, a set of thresholds are defined based on the MCS or modulation order. The gNB then selects the appropriate threshold based on the MCS or modulation order of the PDSCH used to transmit the Paging Message. In further embodiments, the threshold is selected based on any of the following: the paging cause (e.g., SI change indication, PWS indication, DL data arrival, etc.); the characteristics of the service provided to the WTRU(s) being paged (e.g. the QoS of the data that needs to be transmitted to the WTRU); and/or other characteristics of the WTRU(s) being paged (e.g., the WTRU device type).

In embodiments, the gNB uses information characterizing the operation of the RADAR, the paging configuration, and/or the coverage area of the cells served the gNB to determine the interference level that would result to/from the RADAR when using a specific PDCCH monitoring occasion for paging. In embodiments, RADAR AOA and the spatial direction of an SSB, and/or CSI-RS that is QCL-ed with the antenna port(s) used for transmission of the PDSCH carrying the Paging message are be used by the gNB to determine the spatial directions that will incur interference to/from the RADAR in the cells served by the gNB. RADAR pathloss estimates, BW estimates and/or PSD are used to determine the interference level to/from the RADAR for specific RBs/REs that will incur interference to/from the RADAR. In embodiments, RADAR rotation timing estimates, pulse timing estimates, and/or TOA are used to determine the symbols/slots that will incur interference to/from the RADAR. The pagingSearchSpace and associated CORESET are then used to determine the interference that results when using the corresponding PDCCH monitoring occasions for paging.

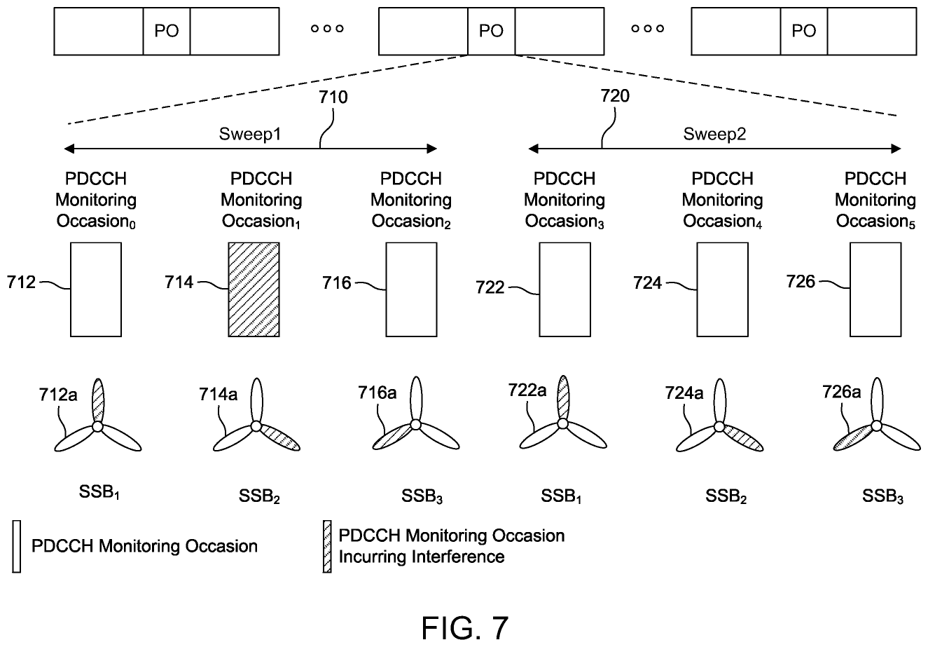

In embodiments shown in FIG. 7 interference to/from the RADAR occurs during the first PDCCH monitoring occasion corresponding to SSB2 (e.g., PDCCH Monitoring Occasion1 714). Monitoring Occasions 712, 714, 716 for Sweep 1, 710 are shown and Monitoring Occasions 722, 724, 726 for Sweep 2, 720 are shown. Corresponding exemplary beam patterns 712a, 714a, 716a, 722a, 724a, 726a are also shown.

In embodiments shown in FIG. 7, the subset of S PDCCH monitoring occasions used for actual paging transmission corresponds to PDCCH monitoring occasions 0, 2, and 4 (712, 716, 724). Alternatively, the subset of S PDCCH monitoring occasions used for actual paging transmission corresponds to the set of PDCCH monitoring occasions associated with Sweep 2 720 (e.g., PDCCH monitoring occasions 3, 4 and 5 (722, 724, 276). In either instance, the interfered with monitoring occasion 714 is avoided and all three beam directions are covered.

Configuring multiple PDCCH monitoring occasions per SSB as shown in FIG. 7 provides the gNB with multiple opportunities for paging transmission in the time domain to avoid interference to/from the RADAR.

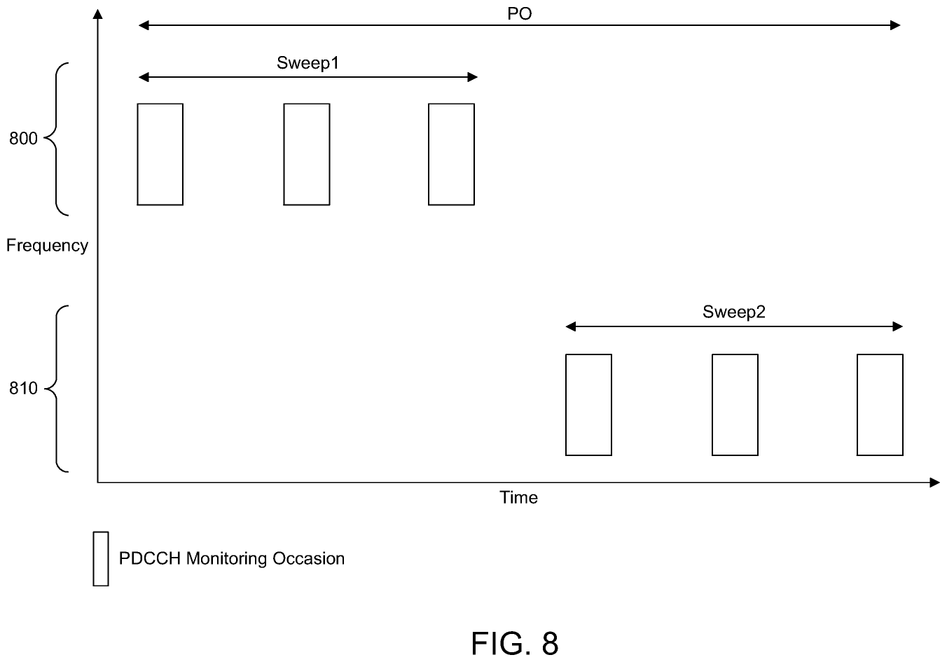

In embodiments, additional opportunities for paging transmission are provided in the frequency domain. In embodiments shown in FIG. 8, a different CORESET configured with different frequency domain resources is used for each sweep. FIG. 8 shows CORESET 800 for Sweep 1 and 810 for Sweep 2. In embodiments, the frequency domain resources used for the CORESETs are configured such that their separation in the frequency domain is greater than or equal to the BW of the RADAR. Alternatively, the CORESETs are configured such that they are at opposing edges of the BWP. In an alternative embodiment, a single CORESET spanning the full BWP may be used.

The UE receives indications about SI modifications and/or PWS notifications using the Short Message field transmitted in the Paging DCI; i.e. DCI format 1_0 with CRC scrambled by P-RNTI. Therefore, interference to PRBs carrying Paging DCI can prevent the UE from reading an SI modification indication and it is possible for the UE to fail to acquire new paging configuration. This issue is critical for UEs in RRC_IDLE and RRC_INACTIVE states as monitoring Paging information is their only way to regain access to the network. To resolve this issue, in embodiments, the UE performs Periodic System Information Check based on a pre-configured timer, SIcheck_timer. Upon expiration of the timer, the UE starts searching for a decodable Paging configuration among multiple pre-configured paging configurations separated in time or frequency as illustrated in FIG. 2 and FIG. 5, respectively.

In embodiments, multiple paging configurations are defined in the time domain. Upon expiration of SIcheck_timer, the UE attemps to decode Paging Configuration 1. If decoding fails due to RADAR interference, the UE proceeds to decode the following Paging Configuration 2 after PF_OFFSET 30 (as shown, for example in FIG. 2), in the following firstPDCCH-MonitoringOccasionOfPO 321 (Error! Reference source not found. 3) or in the following pagingSearchSpace 414 (as shown, for example in FIG. 4). If decoding of Paging Configuration 1 succeeds, the UE will not try to decode Paging Configuration 2.

In embodiments, multiple paging occasions are defined in separate CORESETS corresponding to different frequency resource as illustrated in FIG. 5. Upon expiration of the pre-configured SI Check Timer, the UE attmpts to decode Paging configuration 1 on the first CORESET 500. If decoding fails due to RADAR interference, the UE proceeds to decode Paging configuration 2 on the second CORESET 510. If decoding of Paging Configuration 1 succeeds, UE will not try to decode Paging Configuration 2.

In embodiments, the UE signals its supportability of the System Information Check to the Network via its UE capability message as shown in Table 6 below.

TABLE 6

| | | | FDD − TDD | FR1 − FR2 |
|---|---|---|---|---|
| Definitions of parameters | Per | M | DIFF | DIFF |
| SlcheckSupport | UE | Yes | No | No |
| Indicates whether the UE | | | | |
| may support periodic system | | | | |
| information check. | | | | |

In embodiments a network node (e.g., a base station, gNB, etc.) configured to execute one or more instructions, such as: receiving information characterizing the operation of a RADAR; based on the received information, determining interference to/from the RADAR may occur; and/or, suspending the RRC connection of a plurality of WTRUs being served by the gNB. In a similar example, the same process can occur, but from the WTRU perspective.

In embodiments, the information characterizing the operation of the RADAR may include: RADAR rotation timing estimate, RADAR pulse timing estimate, RADAR pathloss estimate, RADAR Power Spectral Density (PSD), RADAR carrier frequency estimate, RADAR BW estimate, RADAR Angle of Arrival (AOA), RADAR Time of Arrival (TOA), RADAR coordinates estimate, and the like.

In embodiments, the determining interference to/from the RADAR further comprises determining the interference is above a threshold. Further, the MCS of a PDSCH transmitted to a WTRU is used to select the threshold for interference from the RADAR from a set of thresholds based on the MCS.

In embodiments, the plurality of WTRUs is comprised of all WTRUs being served by the gNB.

In embodiments, the plurality of WTRUs may be comprised of WTRUs that cause/incur interference to/from the RADAR.

In embodiments, the WTRUs that cause interference to/from the RADAR are determined based on the WTRU's location.

In embodiments, the WTRUs location is based on the spatial direction of an SS/PBCH block (SSB) or Channel State Information Reference Signal (CSI-RS) that is Quasi-Collocated (QCL-ed) with the antenna port(s) used for transmission/reception when communicating with the WTRU.

In embodiments, the message used to suspend the RRC connection is signaled via broadcast, groupcast or dedicated higher layer signaling.

In embodiments, the message used to suspend the RRC connection includes a timer value determining when the WTRU will resume the RRC connection.

In embodiments, the timer value may be determined based on the time required to reconfigure the gNB to mitigate interference to/from the RADAR.

In embodiments, the timer value isdetermined based on the information characterizing the operation of the RADAR.

In embodiments, a network node (e.g., a base station, gNB, etc.) is configured to execute one or more instructions, such as: determining a first paging configuration for each of the cells served by the gNB; applying the corresponding first paging configuration for each of the cells; transmitting paging in each of the cells in accordance with the corresponding first paging configuration; receiving information characterizing the operation of a RADAR; based on the received information and the coverage area of the cells served by the gNB, determining interference to/from the RADAR may occur for a subset of the cells served by the gNB; determining a second paging configuration for each of the cells in the subset of cells; applying the corresponding second paging configuration for each of the cells in the subset of cells; transmitting paging in each of the cells that is not in the subset of cells in accordance with the corresponding first paging configuration; and/or, transmitting paging in each of the cells that is in the subset of cells in accordance with the corresponding second paging configuration. In further embodiments, the same process occurs from the WTRU perspective.

In embodiments, the information characterizing the operation of the RADAR includes: RADAR rotation timing estimates, RADAR pulse timing estimates, RADAR pathloss estimates, RADAR Power Spectral Density (PSD), RADAR carrier frequency estimates, RADAR BW estimates, RADAR Angle of Arrival (AOA), RADAR Time of Arrival (TOA), RADAR coordinates estimates, etc.

In embodiments, the coverage area of a cell is determined based on the spatial direction of the SS/PBCH blocks (SSB) transmitted by the cell.

In embodiments, the second paging configuration includes a PF_OFFSET corresponding to Paging Frames (PF) that will not incur interference to/from the RADAR.

In embodiments, the second paging configuration includes a firstPDCCH-MonitoringOccasionOfPO parameter for one or more of the POs corresponding to PDCCH monitoring occasions for paging that will not incur interference to/from the RADAR.

In embodiments, the second paging configuration includes a pagingSearchSpace corresponding to slots that will not incur interference to/from the RADAR.

In embodiments, the second paging configuration includes the CORESET associated with the pagingSearchSpace corresponding to RBs that will not incur interference to/from the RADAR.

In embodiments, a network node (e.g., a base station, gNB, etc.) is configured to execute one or more instructions, such as: applying a paging configuration comprising a plurality of POs, where a PO is comprised of a set of ‘S*X’ PDCCH monitoring occasions, where S is the actual number of transmitted SSBs and X is the number of PDCCH monitoring occasions per SSB; receiving information characterizing the operation of a RADAR; based on the received information, the paging configuration and the coverage area of the cells served the gNB, determining a subset of the set of PDCCH monitoring occasions comprising a PO; and/or, transmitting paging during a PO using the determined subset of PDCCH monitoring occasions comprising the PO. In a similar example, the same process may occur, but from the WTRU perspective.

In embodiments, the information characterizing the operation of the RADAR includes: RADAR rotation timing estimates, RADAR pulse timing estimates, RADAR pathloss estimates, RADAR Power Spectral Density (PSD), RADAR carrier frequency estimates, RADAR BW estimates, RADAR Angle of Arrival (AOA), RADAR Time of Arrival (TOA), RADAR coordinates estimates, and/or the like.

In embodiments, the coverage area of a cell is determined based on the spatial direction of the SS/PBCH blocks (SSB) transmitted by the cell.

In embodiments, the subset is comprised of 1 or more PDCCH monitoring occasions for each of the transmitted SSBs, and the PDCCH monitoring occasions for the Kth SSB are selected from the set of X PDCCH monitoring occasions associated with the Kth SSB, where K=1, 2, . . . , S, and the PDCCH monitoring occasions for the Kth SSB selected based on the interference level that would result to/from the RADAR, when using the selected PDCCH monitoring occasion for paging, being below a threshold.

In embodiments, the MCS of the PDSCH used to transmit the Paging Message is used to select the threshold from a set of thresholds based on the MCS.

In embodiments, the plurality of X CORESETs is defined and the xth CORESET is associated with the xth PDCCH monitoring occasion for the Kth transmitted SSB, where x=0,1, . . . , X−1 and K=1, 2, . . . ,S.

As described herein, a higher layer refers to one or more layers in a protocol stack, or a specific sublayer within the protocol stack. The protocol stack can comprise of one or more layers in a WTRU or a network node (e.g., eNB, gNB, other functional entity, etc.), where each layer has one or more sublayers. Each layer/sublayer is responsible for one or more functions. Each layer/sublayer communicates with one or more of the other layers/sublayers, directly or indirectly. In embodiments, these layers are numbered, such as Layer 1, Layer 2, and Layer 3. For example, Layer 3 comprises of one or more of the following: Non Access Stratum (NAS), Internet Protocol (IP), and/or Radio Resource Control (RRC). For example, Layer 2 comprises of one or more of the following: Packet Data Convergence Control (PDCP), Radio Link Control (RLC), and/or Medium Access Control (MAC). For example, Layer 3 comprises physical (PHY) layer type operations. The greater the number of the layer, the higher it is relative to other layers (e.g., Layer 3 is higher than Layer 1). In some cases, the aforementioned examples are called layers/sublayers themselves irrespective of layer number, and are referred to as a higher layer as described herein. For example, from highest to lowest, a higher layer refers to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein refers to a function or operation performed by one or more layers described herein. In some cases, reference to a high layer herein refers to information that is sent or received by one or more layers described herein. In some cases, reference to a higher layer herein refers to a configuration that is sent and/or received by one or more layers described herein.

FIG. 9 illustrates a system according to embodiments including a radar estimator system component 904, in the context of a 5G implementation comprising a 5G Core Network 922+5G gNB ((CU+DU) 924+RU 516) and a plurality of UE 920. The Radar estimator system 504 continuously monitors the band of interest including the 5G band and the adjacent bands that cover radar operation for and detects the presence of radar, which can be an airborne radar 970 and reports the radar parameters to the 5G network. The radar sensor estimator 904 may be integrated into the RU 918, be consisted with the RU and share baseband HW, or be a fully separate physical entity. The radar estimator 904 can cooperate with an Angle of Arrival (AOA) estimator 902 to provide some or all of the parameter values discussed in detail below. Node 924 is configured to cooperate with radar estimator 904 to receive parameters and information from the radar estimator. In some embodiments radar estimator 904 is configured to transmit at regular or scheduled periodic intervals. In other embodiments radar estimator 904 is configured to detect events in the environment such as sensed parameters in excess of thresholds, and to trigger a transmission in response to such events.

In some embodiments radar estimator 904 is configured to provide values for the parameters described below. In some embodiments the values are conveyed in messages, frames or other transport arrangements including fields corresponding to the parameters. Example parameters provided by a radar estimator apparatus and corresponding fields, according to embodiments, include at least one of the following: radar antenna rotation timing estimate; radar pulse timing estimate; radar path-loss estimate; radar received power spectral density (PSD) at a 5G cell; radar AoA, ToA, and coordinates estimate.

With respect to radar antenna rotation timing estimate, one type of radar transmits a train of pulses using a rotating radome and high gain antenna to cover 360 degrees of monitoring with a high gain antenna. Thus, the interference at a gNB follows a pattern of relatively short duration high interference followed by longer duration reduced interference due to the rotating antenna and radome. The antenna rotation is typically periodic, rotating at a nearly fixed rate for long periods of time. The approximate rate of rotation is often known. Based on coherent detection techniques such as matched filter or non-coherent detection techniques such as power envelope detection, temporal estimates of the rotation pattern of interference are estimated and communicated to the 5G system (CN, gNB, CU, DU or RU), e.g. time and value of next interference peak, time between peaks, 30, 20, 10 dB peak width (duration of interference >−10 dBp, −20 dBp, −30 dBp). In embodiments, these patterns are used by the 5G transmitter to reduce the transmission of RF power such that interference to radar is minimized when the radar antenna is facing the 5G gNB.

With respect to radar pulse timing estimate, pulse doppler radars transmit a train of pulses. Following similar detection techniques outlined above, the pulse timing or Pulse Repetition Frequency PRF and pulse width are estimated by the radar estimator and reported to the 5G system (CN, gNB, CU, DU or RU). 5G systems use this information for power control and additional signal processing techniques to overcome radar interference. Multiple PRFs are often used to disambiguate radar returns and different radar modes will use different PRFs and pulse widths. Multiple pulse trains with different PRFs and pulse widths need to be tracked. Example data exchanged by the radar estimator with the 5G system include, for each detected pulse train, PRF, pulse width, pulse start time and pulse end time.

With respect to radar path-loss estimate, path-loss estimates require prior knowledge of the radar transmit power. The difference between the total received power evaluated in the radar bandwidth at the Radar Estimator and the transmitted power, which is known before-hand, is used for path loss estimates. Alternatively, in cases when radar Tx power is not known, multiple radar estimators can coordinate to geo-locate the radar using time difference of arrival or other geo-location algorithms to determine the distance between the radar transmitter and the radar estimator. The pathloss is then estimated using various pathloss models, one such being the free space path loss model. The pathloss estimates are useful to evaluate the aggregate interference caused by 5G systems at the radar receiver based on the transmit power of 5G in the radar interference band and adjacent bands.

With respect to received power spectral density (PSD) at a 5G cell, the radar estimator performs spectral analysis within the bandwidth of interest and provides a power spectral density estimate or transmit mask estimate or an adjacent channel leakage ratio estimate (ACLR) of the interference source. The PSD estimate is then used to evaluate the radar carrier frequency and the bandwidth by comparing the normalized PSD with predefined thresholds. The estimates of carrier frequency and radar bandwidth are useful to identify 5G time-frequency resources that can be subjected to reduced transmit power to limit 5G system interference to radar.

With respect to radar AoA, ToA and coordinate estimates, by using AoA estimators or by using the I/Q samples in the band of the interference (radar), AoA of the interference can be estimated by using well known signal processing algorithms such as beam-scan, minimum variance distortion-less response (MVDR), or multiple signal classification (MUSIC). These angles of arrival, time of arrival are indicated to the 5G gNB. As described above, the radar estimator can use all previous estimates of the geo-location of the radar and track the location of the radar using well known prediction algorithms such as Kalman filtering to estimate the current coordinates of the interferer. Alternatively, based on the terrain information and the coordinates of the radar and the gNB receiver, ray tracing channel modeling can be used to identify the angles of arrival of the interferer at the gNB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of interference mitigation performed by a base station, the method comprising:
receiving RADAR operation information;
determining interference based on the RADAR operation information; and
based on the interference determination, reconfiguring a paging configuration operated by the base station to minimize or eliminate an impact of the interference.

2. The method of claim 1, further comprising:
selecting a first set of wireless transmit receive units (WTRUs) and a second set of WTRUs;
transmitting a first paging message to the first set of WTRUs on a first carrier frequency; and
transmitting a second paging message to the second set of WTRUs on the first carrier frequency;
wherein the first set of WTRUs is impacted by the interference; and the second set of WTRUs is not impacted by the interference.

3. The method of claim 1, further comprising:
determining by the base station, based on the interference determination, a first subset of cells of a plurality of cells where there is not RADAR interference and a second subset of cells of the plurality of cells where there is RADAR interference;
transmitting a first paging message to the first subset of cells in accordance with a first paging configuration; and
transmitting a second paging message to the second subset of cells in accordance with a second paging configuration.

4. The method of claim 3, wherein the first paging message and the second paging message are sent on the same carrier frequency.

5. The method of claim 3, wherein the second paging configuration comprises a first physical downlink control channel (PDCCH) monitoring occasion that avoids time slots during which RADAR interference occurs.

6. The method of claim 3, wherein the second paging configuration comprises a paging search space having time slots that do not occur during periods when RADAR interference occurs.

7. The method of claim 3, wherein the second paging configuration operates in a control resource set that does not occupy a frequency band in which RADAR interference occurs.

8. The method of claim 3, wherein the second paging configuration comprises a first subset of PDCCH monitoring occasions that does not include any monitoring occasions that occur during RADAR interference and wherein the first subset includes monitoring occasions for each antenna beam pattern in which the base station operates.

9. The method of claim 3, wherein the first paging configuration operates in a first control resource set during a first complete antenna pattern sweep and the second paging operation operates in a second control resource set, which is different than the first control resource set and during a second complete antenna pattern sweep.

10. The method of claim 1, wherein the determining interference further comprises determining that the interference is above a threshold.

11. A wireless network for operation in reception range of a system that transmits and receives electromagnetic radiation in a frequency range shared with the wireless network, comprising:
a base station and
an interference estimator, configured to estimate an interference associated with the system that transmits and receives electromagnetic radiation;
wherein the base station is configured to receive the interference estimate and based on the interference estimate reconfigure a paging configuration operated by the base station to minimize or eliminate an impact of the interference.

12. The wireless network of claim 11, wherein the base station is further configured to:
select a first set of wireless transmit receive units (WTRUs) and a second set of WTRUS;
transmit a first paging message to the first set of WTRUs on a first carrier frequency; and
transmit a second paging message to the second set of WTRUs on the first carrier frequency;
wherein the first set of WTRUs is impacted by the interference; and the second set of WTRUs is not impacted by the interference.

13. The wireless network of claim 11, further comprising:
wherein the base station is configured to:
determine, based on the interference determination, a first subset of cells of a plurality of cells where there is not RADAR interference and a second subset of cells of the plurality of cells where there is RADAR interference;
transmit a paging message to the first subset of cells in accordance with a first paging configuration; and
transmit a paging message to the second subset of cells in accordance with a second paging configuration.

14. The wireless network of claim 13, wherein the first paging message and the second paging message are sent on the same carrier frequency.

15. The wireless network of claim 13, wherein the second paging configuration comprises a first physical downlink control channel (PDCCH) monitoring occasion that avoids time slots during which RADAR interference occurs.

16. The wireless network of claim 13, wherein the second paging configuration comprises a paging search space having time slots that do not occur during periods when RADAR interference occurs.

17. The wireless network of claim 13, wherein the second paging configuration operates in a control resource set that does not occupy a frequency band in which RADAR interference occurs.

18. The wireless network of claim 13, wherein the second paging configuration comprises a first subset of PDCCH monitoring occasions that does not include any monitoring occasions that occur during RADAR interference and wherein the first subset includes monitoring occasions for each antenna beam pattern in which the base station operates.

19. A method for operating a wireless transmit/receive unit (WTRU) in a wireless network having a base station and which operates in reception range of a RADAR system comprising:
determining that the WTRU is in a first subset of cells of a plurality of cells where there is RADAR interference; and
receiving a paging message from the base station directed to the first subset of cells in accordance with a first paging configuration, the first paging configuration being configured to avoid paging frames that incur interference to or from the RADAR.

20. The method of operating a WTRU of claim 19, wherein the first paging configuration is reconfigured based on a RADAR interference determination.
